(19) United States
(12) Patent Application Publication
(10) Pub. No.: US 2017/0271777 A1
(43) Pub. Date: Sep. 21, 2017

(54) Connector for Plastic Waveguide

(71) Applicant: STMicroelectronics SA, Montrouge (FR)

(72) Inventors: Baudouin Martineau, Tencin (FR); Olivier Richard, Bilieu (FR); Didier Belot, Rives (FR); Pierre Dautriche, Montbonnot (FR)

(21) Appl. No.: 15/614,382

(22) Filed: Jun. 5, 2017

Related U.S. Application Data
(63) Continuation of application No. 14/726,866, filed on Jun. 1, 2015.

(30) Foreign Application Priority Data
Jun. 24, 2014 (FR) 1455853

(51) Int. Cl. H01Q 13/06; H01P 3/16

(52) U.S. Cl. CPC H01Q 13/06; Y10T 29/49018; H01P 3/16; Y10T 29/4902

(57) ABSTRACT

A connector for a plastic waveguide includes a connector body having first and second openings aligned with one another. The first opening is configured to receive the plastic waveguide. A radio frequency (RF) antenna is positioned within the second opening of the connector body.

### CROSS-REFERENCE TO RELATED APPLICATIONS

This application is a continuation of U.S. application Ser. No. 14/726,866 filed on Jun. 1, 2015, which claims the benefit of France Application No. 1455853 filed on Jun. 24, 2015, which application is hereby incorporated herein by reference.

### TECHNICAL FIELD

The present disclosure generally relates to electronics, and, more specifically, to systems communicating via plastic waveguides. The present disclosure relates to the connection of an end of a plastic waveguide to an electronic circuit.

### BACKGROUND

Optical fiber transmission systems typically use a transmit diode on the transmit circuit side, and a receive diode on the receiver side. The diodes are connected to electronic circuits in optical fiber transmission systems.

Plastic waveguides have recently appeared. Plastic waveguides allow high flow rates (e.g., several gigabits per second) and are simpler and less expensive to manufacture than optical fibers. Plastic waveguides are simpler to implement.

### SUMMARY

A first aspect is directed to connecting a plastic waveguide to an electronic circuit.

A second aspect is directed to a transmission device using a plastic waveguide for transmission and reception.

A connector for a plastic waveguide includes a connector body having first and second openings aligned with one another, with the first opening being configured to receive the plastic waveguide. A radio frequency (RF) antenna may be positioned within the second opening of the connector body.

A connection device includes a first connector supporting a plastic waveguide, and a second connector having a wall supporting the RF antenna. The first connector may be shaped so that a free or first end of the plastic waveguide is, when the two connectors are assembled, located opposite the RF antenna. The second connector may be mechanically assembled on an electronic device, and a terminal of the RF antenna may be electrically connected to a signal generation and/or interpretation circuit.

The first connector may be configured as a male connector, and the second connector may be configured as a female connector. An electromagnetic lens may be supported by one of the connectors. A form factor of the plastic waveguide may be in the millimeter range. The connectors may provide for an electrical connection but they do not having any conductive elements. A rear surface of one of the connectors may be open.

A first connector may support the plastic waveguide, and a second connector may be mechanically attached to an electronic device. The rear end of the second connector may be open opposite a radio transmit and/or receive antenna, and supported by the electronic device. The connectors may be configured as a jack, a USB jack, an HDMI jack, or an RCA jack.

A transmission system using a plastic waveguide is directed to an electronic board provided with an RF signal generation and/or interpretation circuit, and at least one connector of a connection device as described above.

The foregoing and other features and advantages will be discussed in detail in the following non-limiting description of specific embodiments in connection with the accompanying drawings.

### BRIEF DESCRIPTION OF THE DRAWINGS

FIG. 1 is a simplified representation of an example of a transmission system using a plastic waveguide of the type to which the embodiments which will be described apply;

FIG. 2 is a simplified perspective view of an embodiment of a system for connecting a plastic waveguide to an electronic circuit;

FIG. 3 is a cross-sectional view of another embodiment of a system for connecting a plastic waveguide;

FIG. 4 shows an embodiment of a system that transmits and receives via a plastic waveguide; and

FIGS. 5A and 5B are respective perspective and top views of an embodiment of a transmission-reception device using a plastic waveguide.

### DETAILED DESCRIPTION OF ILLUSTRATIVE EMBODIMENTS

The same elements have been designated with the same reference numerals in the different drawings. For clarity, only those elements which are useful to the understanding of the embodiments which will be described have been shown and will be detailed. In particular, generation of the signals to be transmitted via the plastic waveguide has not been detailed. The described embodiments are compatible with known techniques for generating such signals. Similarly, on the receive side, use of the signals received from a plastic waveguide has not been detailed either. The described embodiments are compatible with known approaches.

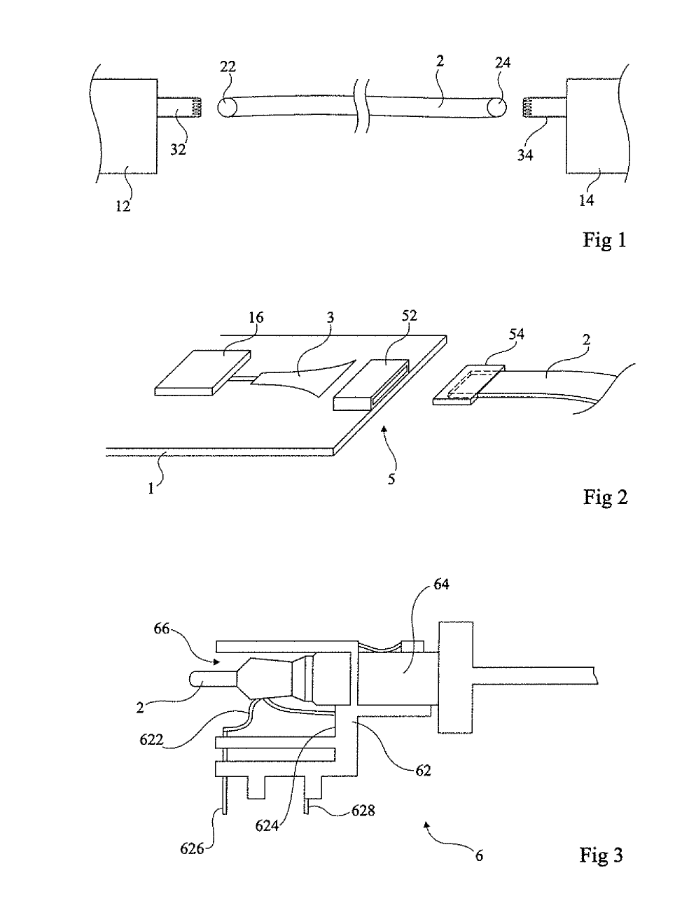

FIG. 1 is a simplified representation of an example of a data transmission system between two devices 12 and 14 using a waveguide 2 made of a plastic material. This technology involves generating, by way of an antenna 32 coupled to a transmit device (for example, device 12), a radio frequency signal towards an end 22 of a plastic waveguide 2. At the other end 24 of the plastic waveguide 2, an antenna 34, associated with device 14, is placed facing this end to capture the radio frequency signal which has been conveyed by the plastic waveguide 2. According to applications, dedicated transmit and receive antennas may be used. Alternatively, each antenna 32, 34 may be used both as a transmit and receive antenna.

The practical forming of a plastic waveguide 2 and the transmit and receive circuits within the devices 12 and 14 may, for example, be inspired from the approaches discussed in the following articles: “A 12.5+12.5 Gb/s Full-Duplex Plastic Waveguide Interconnect”, by Fukuda et al., published in IEEE Journal of Solid-State Circuits, Vol. 46, Number 12 Dec. 2011; and “A plastic waveguide receiver in 40 nm CMOS with on-chip bondwire antenna”, by Tytgat et al., published in “The Proceeding of the 39th IEEE European Solid-State Circuits Conference”, Bucharest, 16-20 Sep. 2013. For an industrial application using plastic waveguides, there is a problem of connecting the waveguides to the electronic circuits arises.

FIG. 2 is a perspective representation of an embodiment of a system for connecting a plastic waveguide. This example assumes an electronic board 1 belonging to a transmit device 12 or to a receive device 14. The electronic board 1 supports one or more circuits 16 for generating radio frequency signals to be applied to an antenna 3. In the example of FIG. 2, the antenna 3 is a planar antenna on the electronic board 1. The antenna 3 is placed opposite an opening of a female connector 52 of a connection device 5 having a male connector 54 supporting an end of the plastic waveguide 2.

In the example of FIG. 2, the connection device 5 is a USB-type connection device. A USB-type connection device means that there are no electrical contacts in the connection. Thus, according to the embodiments described in relation with the first aspect, the mechanical elements of existing connectors are used to connect a plastic waveguide. The use of existing connectors has many advantages in terms of manufacturing and connection to the electronic board 1. The possible adaptation of such existing connectors includes making sure that the connectors are open at both their ends to enable, once the mechanical connection has been established, to place the end 22 of the plastic waveguide 2 opposite the antenna 3.

An advantage is taken from the fact that most existing devices requiring an electrical connection at the level of electronic boards have a form factor compatible with that of a plastic waveguide and, particularly, a form factor having dimensions on the order of one or more millimeters.

FIG. 3 is a cross-sectional view of another embodiment of a connection device 6 using existing connectors. According to this example, a jack-type connection device is used. As compared with a usual jack connector, the core of the male connector 64 is replaced with a plastic device 2 (having a circular cross-section). The female connector 62, which is supported by the electronic board 1, may be a standard connector, for example. However, the contact areas of the core (spring 622) and the frame (support 624) are not electrically connected. In this example, they are used for their mechanical functions only. Elements 626 and 628 mechanically attach the female connector 62 on an electronic board, such as the electronic board 1 in FIG. 2.

As in the example of FIG. 2, the female connector 62 is arranged so that its rear opening 66 is opposite the circuit antenna (not shown) or, at least, the end of the waveguide 2 receives the radio frequency signals.

More generally, according to this first aspect, a connection device of the type currently used to transmit electrical data or electrical power supply signals is provided as a mechanical device for connection to a plastic waveguide. It may be, for example, a connector known as a jack, an HDMI jack and variations thereof, a USB jack and variations thereof, an RCA jack, etc., which may be modified if needed so that it is open in the back at the level of its male and female connectors. The opening is to enable, on one side, the passing of the waveguide in the same way as the electrical cable in a conventional use and, on the other side, the passing of the radio frequency signals generated by the antenna.

It should be noted that for connection reasons, it may be preferable for the waveguide to be supported by the male connector and for the female connector to be on the side of the transmit/receive circuit. However, the opposite is also possible.

FIG. 4 is a very simplified cross-sectional view of an embodiment of a transmit-receive device using a connection device 7 on an electronic board 1. The female connector 72 of the connection device 7 is assumed to be attached to the electronic board 1 and open at the back (opening 76) opposite an antenna 3 supported by an electronic transmit circuit 16. In this example, the antenna 3 is assumed to be directly formed on the electronic circuit 16. The plastic waveguide 2 is supported by a male connector 74 of the connection device 7.

Based on optical devices, the use of current mechanical systems for providing an electrical connection would seem to be excluded due to the positioning tolerances thereof. However, an advantage may be taken from the fact that, for a plastic waveguide, the transmission uses higher frequencies (for example, several tens of GHz). Accordingly, the wavelengths are larger (in the millimeter range) and allow a less accurate positioning than in the case of an optical fiber. This makes it possible to use standard electrical connectors.

According to an embodiment of a second aspect, a connection device for a plastic waveguide having a connector supporting the waveguide and the other connector supporting a transmit-receive antenna is provided.

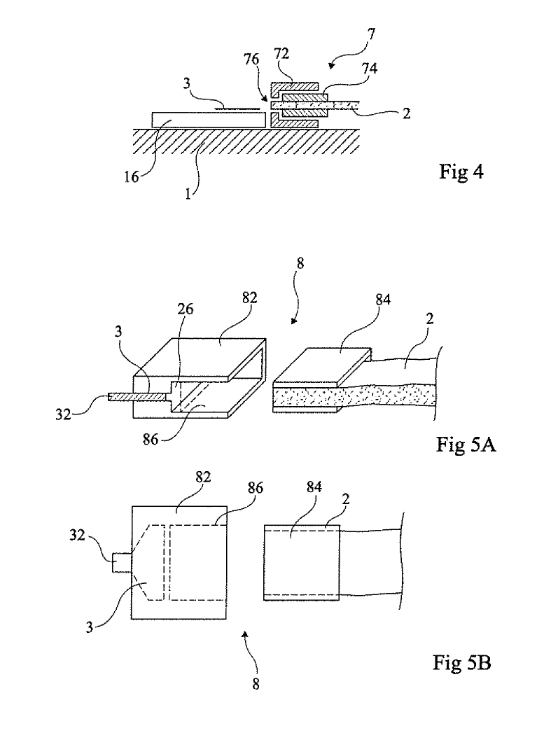

FIGS. 5A and 5B are a respective perspective cross-sectional view and a top view of an embodiment of such a connection device 8. In this example, an antenna 3 is supported by a female connector 82, and a waveguide 2 is supported by a male connector 84. The shape given to the female connector 82 is such that an opening 86 for receiving the male connector ends, at the back, in front of the antenna 3. The antenna 3 includes a terminal 32 for electrical connection to an electronic circuit (12 or 14 in FIG. 1). More precisely, the terminal 32 may be connected to an output terminal of a transmit/receive circuit 16.

FIG. 5A also illustrates a variation according to which, to improve the transmission, an electromagnetic lens 26 is placed at the end of the waveguide 2. In the example of FIG. 5A, the electromagnetic lens 26 is placed at the bottom of the female connector 82. As a variation, the lens 26 may be placed at the end of the waveguide on the male connector side. The female connector 82 is intended to be assembled, for example, on an electronic board 1 instead of connectors 62 or 72.

An advantage of the described embodiments is that may now be possible to easily connect a plastic waveguide to an electronic board or to a transmit/receive circuit. Another advantage of the first described aspect is that using existing connectors makes the implementation easier.

Various embodiments have been described. Various alterations and modifications will occur to those skilled in the art. In particular, other mechanical devices currently used for electrical connections in electronics may be adapted to the connection of an optical waveguide by using the above-described principles. Further, a cross-section of the waveguide depends on different factors independent from the connector cross-section. The form factors of known connectors are compatible with wavelengths used with plastic waveguides. Further, the practical implementation of the described embodiments is within the abilities of those skilled in the art based on the functional indications given above.

Such alterations, modifications, and improvements are intended to be part of this disclosure, and are intended to be within the spirit and the scope of the present invention. Accordingly, the foregoing description is an example and is not intended to be limiting. The present invention is limited only as defined in the following claims and the equivalents thereto.

What is claimed is:

1. An electronic device comprising:
a plastic waveguide having a first end;
a first connector coupled to the first end of said plastic waveguide;
a second connector comprising
a connector body having first and second openings aligned with one another, with the first opening configured to receive said first connector; and
a radio frequency (RF) antenna positioned within the second opening of said connector body;
an electromagnetic lens configured to focus electromagnetic waves disposed in said second connector, said electromagnetic lens being positioned between said RF antenna and said first connector;
an electronic board, with said second connector being carried by said electronic board; and
an RF signal generating circuit coupled to said RF antenna and carried by said electronic board.

2. The electronic device of claim 1, wherein said first connector is configured so that the first end of said plastic waveguide is aligned with said RF antenna when received by the first opening of said connector body.

3. The electronic device of claim 1, wherein said first connector is configured as a male connector, and said second connector is configured as a female connector.

4. The electronic device of claim 1, wherein a diameter of said plastic waveguide in at least one millimeter.

5. The electronic device of claim 1, wherein said first and second connectors are configured as at least one of a jack, a USB jack, an HDMI jack, and an RCA jack.

6. A transmission system comprising:
an electronic board;
a radio frequency (RF) generating circuit carried by said electronic board; and
a connection device comprising
a plastic waveguide having a first end,
a first connector coupled to the first end of said plastic waveguide, and
a second connector comprising
a connector body having first and second openings aligned with one another, with the first opening configured to receive said first connector, and
a radio frequency (RF) antenna positioned within the second opening of said connector body;
an electromagnetic lens configured to focus electromagnetic waves disposed in said second connector, said electromagnetic lens being positioned between said RF antenna and said first connector;
wherein the second connector is carried by said electronic board; and
an RF signal generating circuit coupled to said RF antenna and carried by said electronic board.

7. The transmission system of claim 6, wherein said first connector is configured so that the first end of said plastic waveguide is aligned with said RF antenna when received by the first opening of said connector body.

8. The transmission system of claim 6, wherein said first connector is configured as a male connector, and said second connector is configured as a female connector.

9. The transmission system of claim 6, further comprising an electromagnetic lens carried by said second connector, with said electromagnetic lens positioned between said RF antenna and said first connector.

10. The transmission system of claim 6, wherein a diameter of said plastic waveguide in at least one millimeter.

11. The transmission system of claim 6, wherein said first and second connectors are configured as at least one of a jack, a USB jack, an HDMI jack, and an RCA jack.

12. A method for making a connection device comprising:
coupling a first connector to a first end of a plastic waveguide;
providing a second connector comprising a connector body having first and second openings aligned with one another;
positioning the first connector in the first opening of the connector body of the second connector;
positioning a radio frequency (RF) antenna within the second opening of the connector body of the second connector;
positioning the second connector on an electronic board;
positioning an RF signal generating circuit on the electronic board;
coupling the RF antenna to the RF signal generating circuit; and
positioning an electromagnetic lens configured to focus electromagnetic waves within the second connector, the electromagnetic lens being positioned between the RF antenna and the first connector.

13. The method of claim 12, wherein the first connector is configured so that the first end of the plastic waveguide is aligned with the RF antenna.

14. The method of claim 12, wherein the first connector is configured as a male connector, and the second connector is configured as a female connector.

15. The method of claim 12, wherein a diameter of said plastic waveguide in at least one millimeter.

16. The method of claim 12, wherein the first and second connectors are configured as at least one of a jack, a USB jack, an HDMI jack, and an RCA jack.

17. A transmission system comprising:
an electronic board;
a radio frequency (RF) generating circuit disposed over the electronic board;
a planar antenna coupled to the RF generating circuit and disposed over the electronic board;
a first connector disposed over the electronic board, the first connector separated from the planar antenna by a gap; and
an opening disposed in the first connector, the opening configured to receive a plastic waveguide, wherein the first connector is configured to detachably attach to a second connector holding the plastic waveguide.

18. The system of claim 17, wherein the planar antenna is disposed over the RF generating circuit.

19. The system of claim 17, wherein the first connector comprises a plurality of springs configured for holding the plastic waveguide.

20. The system of claim 17, wherein the first connector comprises a plurality of elements for mechanically attaching the second connector on the electronic board.

21. A transmission system comprising:
a first connector configured to detachably attach to a second connector, the second connector comprising one end of a plastic waveguide;
an electromagnetic lens configured to focus electromagnetic waves disposed in the second connector;
a radio frequency (RF) antenna disposed in the first connector; and
a RF signal generating circuit coupled to the RF antenna.
